(19) United States
(12) Patent Application Publication
(10) Pub. No.: US 2014/0167701 A1
(43) Pub. Date: Jun. 19, 2014

(54) Power Converter and its Control Method

(71) Applicant: Hitachi, Ltd., Tokyo (JP)

(72) Inventors: Yasuhiro NAKATSUKA, Tokyo (JP); Yasuhiro IMAZU, Tokyo (JP); Akihiro MAOKA, Tokyo (JP); Masaya ICHINOSE, Tokyo (JP); Yasuhiro KIYOFUJI, Tokyo (JP); Akira BANDO, Tokyo (JP)

(73) Assignee: Hitachi, Ltd., Tokyo (JP)

(21) Appl. No.: 14/096,294

(22) Filed: Dec. 4, 2013

(30) Foreign Application Priority Data
Dec. 14, 2012 (JP) 2012-273156

(51) Int. Cl. H02J 7/02

(52) U.S. Cl. CPC H02J 7/022
USPC 320/134

(57) ABSTRACT

The invention provides a power converter including a plurality of power conversion units each connected to a different feeder, a DC energy interchange unit connected to the power conversion units and connected to a secondary battery, and a power control unit which instructs the regeneration-side power conversion unit connected to the regeneration-side feeder of the feeders, through which a regenerative current flows, and the consumption-side power conversion unit connected to the consumption-side feeder through which a current consumption flows, to output power from the regeneration-side feeder to the consumption-side feeder through the DC energy interchange unit. The power control unit also determines the voltage of the DC energy interchange unit in such a manner as to input/output energy corresponding to the sum of regenerative power of the regeneration-side feeder and consumed power of the consumption-side feeder to and from the secondary battery.

### BACKGROUND OF THE INVENTION

1. Field of the Invention

The present invention relates to a power converter capable of mutually interchanging power between feeders and to a control method for the power converter.

2. Description of the Related Art

A regenerative brake refers to the application of brake by using a motor normally employed as a drive source as a generator, thereby converting kinetic energy into electrical energy and recovering it. A recent railway vehicle has often been equipped with the regenerative brake. Power regenerated by the regenerative brake is consumed by another railway vehicle via a feeder.

There is described in the problems of the summary in JP-2010-221888-A saying “provides an alternative current feeding device which performs parallel feeding during sections of feeding from two feeding substations different in power grid.” In JP-2010-221888-A “means for solving the problems” describes that “there is provided an alternative current feeding device connecting a first feeding section and a second feeding section, the alternative current feeding device including a first AC-DC converter connected to the end part of the first feeding section, a second AC-DC converter connected to the end part of the second feeding section, and a capacitive DC circuit connected between a DC input/output end on the positive side in the first AC-DC converter and a DC input/output end on the negative side in the first AC-DC converter and further connected between a DC input/output end on the positive side in the second AC-DC converter and a DC input/output end on the negative side in the second AC-DC converter”.

There is described in the problems of the summary in JP-2005-205970-A saying “maintains both of feeder terminal voltage on both sides of a section post at a predetermined voltage and enables effective utilization of regenerative energy”. In JP-2005-205970-A “means for solving the problems” describes that “an AC-DC converter 42A is connected to a single-phase AC feeder 3A, and an AC-DC converter 42B is connected to a single-phase AC feeder 3B so as to compensate a voltage fluctuation at feeder terminal ends. At the same time, a DC-AC converter 42C is connected between a DC circuit common to the converters (42A, 42B) and a power storage element 44 to compensate a fluctuation in power caused by the above feeder voltage compensation, thereby solving the described problems.”

### SUMMARY OF THE INVENTION

Conventionally, power that a railway vehicle regenerates by a regenerative brake flows through a feeder of the railway vehicle. This regenerative power has been discarded wastefully where other railway vehicles related to the corresponding feeder cannot consume it.

In the invention described in JP-2005-205970-A, power is mutually converted between two feeders and stored in a secondary battery, thereby making it possible to store and effectively utilize regenerative energy (regenerative power). In the invention described in the JP-2005-205970-A, however, a power converter is connected between the secondary battery and a DC circuit. There is, therefore, a possibility that a power loss by the power converter occurs.

In the invention described in JP-2010-221888-A, a power converter that mutually converts power between two feeders is equipped with a capacitive DC circuit including a secondary battery to perform a power conversion between the two feeders. There is, however, no disclosure on how to control the secondary battery to store the regenerative power and how to effectively utilize the regenerative power stored in the second battery.

Therefore, an object of the present invention is to provide a power converter capable of interchanging and utilizing power regenerated by an electric motor and to provide a control method for the power converter.

In order to solve the above problems, the invention provides a power converter including a plurality of power conversion units each connected to a different feeder, a DC energy interchange unit connected to the power conversion units and a secondary battery, and a power control unit which instructs the regeneration-side power conversion unit connected to the regeneration-side feeder of the feeders, through which a regenerative current flows, and the consumption-side power conversion unit connected to the consumption-side feeder thereof through which a current consumption flows, to output power from the regeneration-side feeder to the consumption-side feeder through the DC energy interchange unit. The power control unit also determines the voltage of the DC energy interchange unit in such a manner as to input/output energy corresponding to the sum of regenerative power of the regeneration-side feeder and consumed power of the consumption-side feeder to/from the secondary battery.

Other means will be described in the modes for carrying out the invention.

The present invention makes it possible to provide a power converter capable of interchanging and utilizing power regenerated by an electric motor and to provide a control method for the power converter.

### BRIEF DESCRIPTION OF DRAWINGS

These and other features, objects, and advantages of the present invention will become more apparent from the following description when taken in conjunction with the accompanying drawings wherein:

FIG. 1 is a schematic configuration diagram showing a power converter according to a first embodiment;

FIG. 2 is a diagram illustrating the details of the power converter according to the first embodiment;

FIG. 3 is a graph depicting charging characteristics of a secondary battery;

FIG. 4 is a diagram showing a logical configuration of a power control unit in the first embodiment;

FIG. 5A is a diagram showing a method of calculating the charge and discharge amount, and FIG. 5B is a diagram showing a method of calculating the interchange amount;

FIG. 6 is a schematic configuration diagram showing a power converter according to a second embodiment;

FIG. 7 is a diagram illustrating a logical configuration of a power control unit in the second embodiment;

FIG. 8A is a diagram showing a method of calculating the charge and discharge amount, and FIG. 8B is a diagram showing a method of calculating the interchanged amount;

FIG. 9 is a schematic configuration diagram depicting a power converter according to a third embodiment;

FIG. 10 is a diagram illustrating a logical configuration of a power control unit in the third embodiment; and

FIG. 11 is a diagram showing a relationship between railway lines and feeders in the third embodiment.

### DESCRIPTION OF THE PREFERRED EMBODIMENTS

Modes for carrying out the invention will hereinafter be described in detail with reference to the accompanying drawings.

### First Embodiment

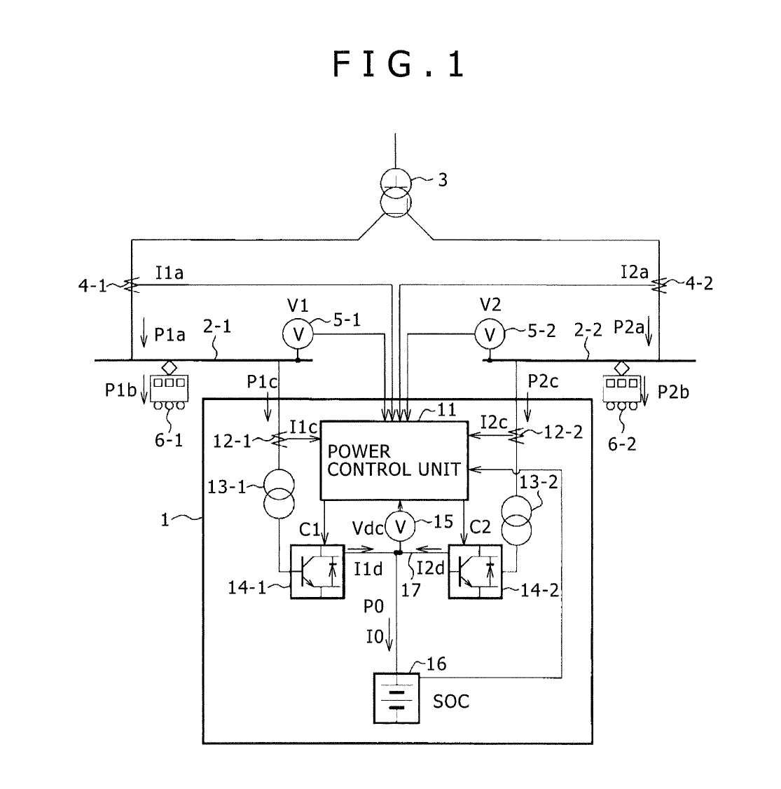

FIG. 1 is a schematic configuration diagram showing a power converter according to a first embodiment.

The power converter 1 is connected to a feeder 2-1 (first feeder) and a feeder 2-2 (second feeder) and mutually converts and interchanges power between these feeders (2-1, 2-2). Since the feeders (2-1, 2-2) are configured in like manner, the feeder 2-1 will be described as a representative, and the description of the feeder 2-2 is therefore omitted. The feeders 2-1, 2-2, . . . will hereinafter be described simply as feeders 2 when not distinguished from each other in particular.

The feeder 2-1 operates a railway vehicle 6-1 with a single-phase AC of a BT (Booster Transformer) feeding system supplied from a transformer 3. The feeder 2-1 is connected to the transformer 3 through an ammeter 4-1 and connected to one terminal of the power converter 1 so as to exchange power through a pantograph of the railway vehicle 6-1. A current flowing in the direction of the feeder 2-1 through the ammeter 4-1 is a supply current I1a. A voltage applied to the feeder 2-1 is a voltage V1. Power supplied to the feeder 2-1 is a supply power P1a. Power interchanged from the feeder 2-1 to the power converter 1 is an interchange power P1c.

The transformer 3 has one end connected to a three-phase AC system (not shown), a first other end connected to the feeder 2-1 through the ammeter 4-1, and a second other end connected to the feeder 2-2 through an ammeter 4-2. The power converter 1 here minimizes a power amount supplied from the AC system to thereby make it possible to minimize power costs of the feeders (2-1, 2-2). The transformer 3, which is of for example a Scott connection transformer, converts the voltage of the three-phase AC system to a single-phase AC of a prescribed voltage and supplies the same to the feeders 2-1 and 2-2.

The ammeter 4-1 has one end connected to the transformer 3, the other end connected to the feeder 2-1, and a sensor output connected to the power control unit 11 through a communication line. The ammeter 4-1 measures and outputs the supply current I1a supplied to the feeder 2-1. The ammeter 4-2 is similar to the ammeter 4-1. The ammeters 4-1, 4-2, . . . will hereinafter be described simply as ammeters 4 when not distinguished from each other in particular.

A voltmeter 5-1 has one end connected to the feeder 2-1, and a sensor output connected to the power control unit 11 through a communication line. The voltmeter 5-1 measures and outputs the voltage V1 applied to the feeder 2-1. The voltage V1 is an effective value of the voltage of the single-phase AC. A voltmeter 5-2 is similar to the voltmeter 5-1. The voltmeters 5-1, 5-2, . . . will hereinafter be described simply as voltmeters 5 when not distinguished from each other in particular.

The railway vehicle 6-1 is a vehicle that runs on electrified railway lines. The railway vehicle 6-1 consumes power using a motor as a drive source upon its acceleration, applies brakes using the motor as a generator upon its deceleration, and regenerates power from kinetic energy in conjunction with it. The power consumed by the railway vehicle 6-1 is a consumed/regenerative power P1b. Although a plurality of vehicles is considered to run along the feeder 2-1, the vehicles are modeled as the railway vehicle 6-1, and the sum of power of these vehicles is assumed to be the consumed/regenerative power P1b. When the consumed/regenerative power P1b is positive, the railway vehicle 6-1 supplies current consumption and consumes power. When the consumed/regenerative power P1b is negative, the railway vehicle 6-1 supplies a regenerative current and regenerates power. A railway vehicle 6-2 is also similar to the railway vehicle 6-1. The railway vehicles 6-1, 6-2, . . . will hereinafter be descried simply as railway vehicles 6 when not distinguished from each other in particular.

The power converter 1 is connected to the sensor output of the voltmeter 5-1, and the sensor output of the ammeter 4-1. Thus, the power converter 1 is capable of measuring the voltage V1 of the feeder 2-1 and the supply current I1a to the feeder 2-1 and calculating the supply power P1a. Likewise, the power converter 1 is connected to a sensor output of the voltmeter 5-2, and a sensor output of the ammeter 4-2. Thus, the power converter 1 is capable of measuring a voltage V2 of the feeder 2-2 and a supply current I2a to the feeder 2-2 and calculating a supply power P2a.

The power converter 1 includes a power control unit 11, an ammeter 12-1 that measures an interchange current I1c, a transformer 13-1, a power conversion unit 14-1 that mutually converts power, an ammeter 12-2 that measures an interchange current 12c, a transformer 13-2, a power conversion unit 14-2 that mutually converts power, a voltmeter 15 that measures a DC-portion voltage Vdc, a secondary battery 16, and a DC energy interchange unit 17.

The power control unit 11 has a first output terminal connected to the power conversion unit 14-1 through a communication line to output a control signal C1, and a second output terminal connected to the power conversion unit 14-2 through a communication line to output a control signal C2. The power control unit 11 controls the power conversion unit 14-1 by the control signal C1 and controls the power conversion unit 14-2 by the control signal C2 to thereby accommodate power between the feeders (2-1, 2-2) and store surplus energy that cannot be interchanged, in the secondary battery 16.

The ammeter 12-1 has one end connected to the feeder 2-1, the other end connected to the transformer 13-1, and a sensor output terminal connected to the power control unit 11 through a communication line. The ammeter 12-1 measures the interchange current I1c flowing from the feeder 2-1 to the transformer 13-1 and transmits the measured value of current to the power control unit 11 through the communication line. The ammeter 12-2 is similar to the ammeter 12-1. The ammeters (12-1, 12-2) will hereinafter be described simply as ammeters 12 when not distinguished from each other in particular.

The transformer 13-1 has one end connected to the feeder 2-1 through the ammeter 12-1 and the other end connected to the power conversion unit 14-1. The transformer 13-1 converts the voltage V1 of the feeder 2-1 to a prescribed voltage capable of power conversion by the power conversion unit 14-1. The transformer 13-2 is similar to the transformer 13-1. The transformers 13-1, 13-2, . . . will hereinafter be described simply as transformers 13 when not distinguished from each other in particular. The transformer 13-1 is not an essential configuration requirement, and a configuration may be adopted in which the power conversion unit 14-1 and the feeder 2-1 are directly connected to each other. At this time, the ammeter 12-1 measures current flowing from the feeder 2-1 to the power conversion unit 14-1 and transmits the measured value of current to the power control unit 11 through the communication line.

The power conversion unit 14-1 is of, for example, a single-phase three level converter and has one end connected to the transformer 13-1, the other end connected to the DC energy interchange unit 17, and a control terminal connected to the power control unit 11 through a communication line. The power conversion units 14-1, 14-2, . . . will hereinafter be described simply as power conversion units 14 when not distinguished from each other in particular.

When the regenerative current flows through the feeder 2-1 and the regenerative power is generated (consumed/regenerative power P1b is negative), the power control unit 11 instructs the power conversion unit 14-1 to accommodate the feeder 2-2 with this regenerative power.

The power control unit 11 instructs the power conversion unit 14-1 to determine the DC-portion voltage Vdc in such a manner that if the SOC (State of Charge) of the secondary battery 16 satisfies a predetermined condition, energy corresponding to the sum of consumed/regenerative power of the respective feeders 2 is input to and output from the secondary battery. The power control unit 11 instructs the power conversion unit 14-1 to determine the DC-portion voltage Vdc so as to avoid the input/output of energy to and from the secondary battery 16 if the SOC of the secondary battery 16 does not satisfy the predetermined condition.

When the regenerative power is generated in the feeder 2-2 (the consumed/regenerative power P2b is negative), the power control unit 11 instructs the power conversion unit 14-2 to accommodate the feeder 2-1 with this regenerative power.

The power control unit 11 instructs the power conversion unit 14-2 to determine an interchange current I2c in such a manner that if the SOC of the secondary battery 16 satisfies the predetermined condition, energy corresponding to the sum of consumed/regenerative power of the respective feeders 2 is input to and output from the secondary battery. The power control unit 11 instructs the power conversion unit 14-2 to determine the interchange current I2c so as to avoid the input/output of energy to and from the secondary battery 16 if the SOC of the secondary battery 16 does not satisfy the predetermined condition.

The voltmeter 15 has one end connected to the DC energy interchange unit 17 and a sensor output terminal connected to the power control unit 11 through a communication line. The voltmeter 15 measures the DC-portion voltage Vdc applied to the DC energy interchange unit 17 and transmits the measured value of voltage to the power control unit 11 through the communication line.

The secondary battery 16 is connected to the DC energy interchange unit 17 and has an SOC output terminal connected to the power control unit 11 through a communication line. The secondary battery 16 receives and outputs surplus energy corresponding to the sum of the consumed/regenerative power P1b of the feeder 2-1 and the consumed/regenerative power P2b of the feeder 2-2. The secondary battery 16 further outputs information on the SOC of the corresponding battery to the power control unit 11.

The DC energy interchange unit 17 is connected to the DC side of the power conversion unit 14-1 and the DC side of the power conversion unit 14-2. Further, the DC energy interchange unit 17 is connected to the secondary battery 16 so as to include the secondary battery 16. The DC energy interchange unit 17 mutually interchanges energy between the power conversion units (14-1, 14-2) and the secondary battery 16.

A current I1d flows from the power conversion unit 14-1 to the DC energy interchange unit 17.

A current I2d flows from the power conversion unit 14-2 to the DC energy interchange unit 17.

A charge/discharge current I0 flows from the DC energy interchange unit 17 to the secondary battery 16. When the charge/discharge current I0 is positive, it is charged into the secondary battery 16. When the charge/discharge current I0 is negative, it is discharged from the secondary battery 16.

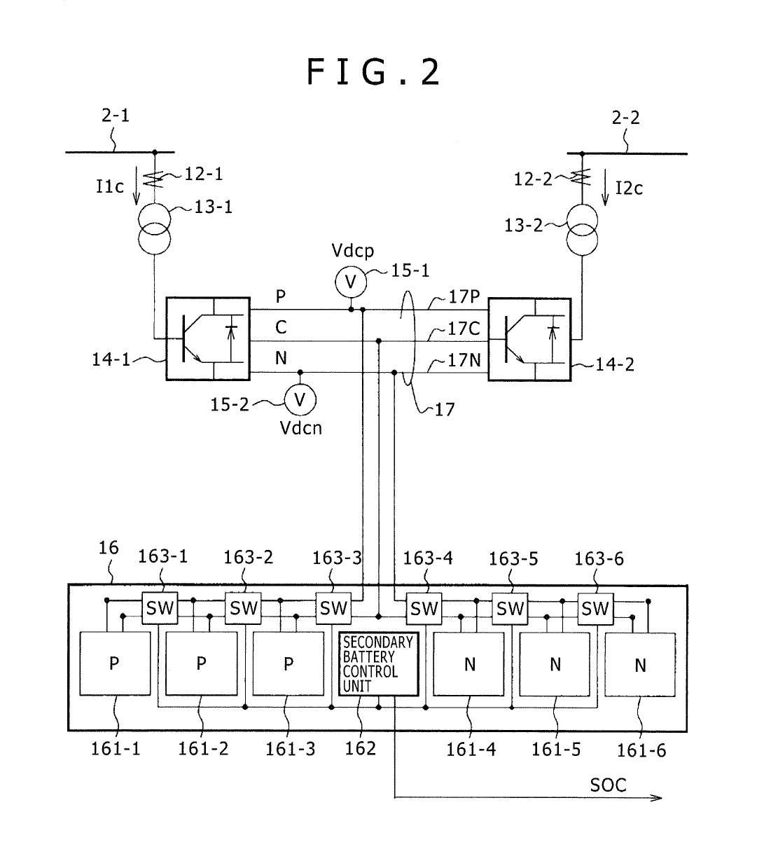

FIG. 2 is a diagram showing the details of the power converter according to the first embodiment.

The DC energy interchange unit 17 includes a central point 17C grounded, a positive point 17P to which a positive DC voltage is applied, and a negative point 17N to which a negative DC voltage is applied. The voltmeter 15-1 is connected to the positive point 17P. The voltmeter 15-2 is connected to the negative point 17N.

The voltmeter 15-1 has one end connected to the positive point 17P of the DC energy interchange unit 17. The voltmeter 15-1 measures a positive point voltage Vdcp applied to the positive point 17P. The voltmeter 15-2 has one end connected to the negative point 17N of the DC energy interchange unit 17. The voltmeter 15-2 measures a negative point voltage Vdcn applied to the negative point 17N. The power control unit 11 (refer to FIG. 1) adds the positive point voltage Vdcp measured by the voltmeter 15-1 and the negative point voltage Vdcn measured by the voltmeter 15-2 to calculate a DC-portion voltage Vdc.

The secondary battery 16 includes battery units (161-1 to 161-6), a secondary battery control unit 162, and switch circuits (163-1 to 163-6). The battery units (161-1 to 161-6) will hereinafter be described simply as battery units 161 when not distinguished from each other in particular. The switch circuits (163-1 to 163-6) will hereinafter be described simply as switch circuits 163 when not distinguished from each other in particular.

The battery units (161-1 to 161-3) are connected between the central point 17C and the positive point 17P through the switch circuits (163-1 to 163-3) and applied with the positive point voltage Vdcp. The battery units (161-4 to 161-6) are connected between the negative point 17N and the central point 17C through the switch circuits (163-4 to 163-6) and added with the negative point voltage Vdcn. The positive point voltage Vdcp and the negative point voltage Vdcn are respectively almost half of the DC-portion voltage Vdc. It is thus possible for the secondary battery 16 to set its breakdown voltage characteristic to half of the DC-portion voltage Vdc.

The secondary battery control unit 162 is connected to control terminals of the switch circuits (163-1 to 163-6) to switch on/off these switch circuits (163-1 to 163-6).

The battery unit 161-3 is connected between the central point 17C and the positive point 17P through the switch circuit 163-3. The battery unit 161-2 is connected between the central point 17C and the positive point 17P through the switch circuits (163-2, 163-3). The battery unit 161-1 is connected between the central point 17C and the positive point 17P through the switch circuits 163-1 through 163-3. The battery units (161-4 to 161-6) and the switch circuits (163-4 to 163-6) are also configured in like manner. Thus, since the secondary battery control unit 162 can be separated from the DC energy interchange unit 17 for each battery unit 161, the battery unit 161 can easily be exchanged upon the occurrence of a fault in the battery unit 161.

The secondary battery control unit 162 further measures the output voltage, output current, temperature and the like of the respective battery units 161 by various sensors (not shown) to calculate information of SOC and outputs the same to the power control unit 11 (refer to FIG. 1).

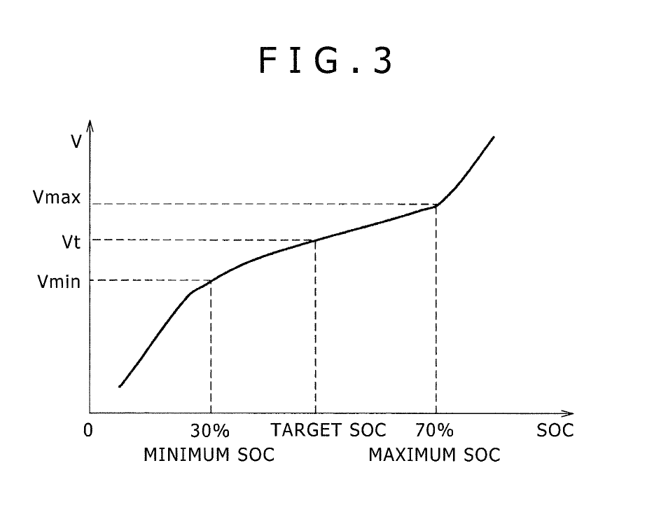

FIG. 3 is a graph showing the charging characteristic of the secondary battery.

The horizontal axis of the graph indicates SOC of the secondary battery 16. The vertical axis of the graph indicates voltage V of the secondary battery 16. The secondary battery control unit 162 calculates the SOC of each battery unit 161 and the SOC of the secondary battery 16 based on the output voltage of each battery unit 161 and the characteristic of the corresponding graph and then outputs them to the power control unit 11 (refer to FIG. 1).

The SOC-voltage characteristic of the secondary battery 16 is almost linear between 30% and 70%. When the SOC is 30%, the secondary battery 16 outputs a voltage Vmin. When the SOC is 70%, the secondary battery 16 outputs a voltage Vmax. When the SOC is a target SOC, the secondary battery 16 outputs a voltage Vt. The power control unit 11 in the first embodiment controls the SOC of the secondary battery 16 in such a manner that it falls within at least a range 30% to 70%. The SOC thereof is however not limited to it, but may be controlled to fall within an arbitrary SOC range.

The power control unit 11 in the first embodiment further sets the target SOC to approximately 50% in order to cause the secondary battery 16 to have sufficient charging and discharging remaining power and prolong the life of each battery unit 11.

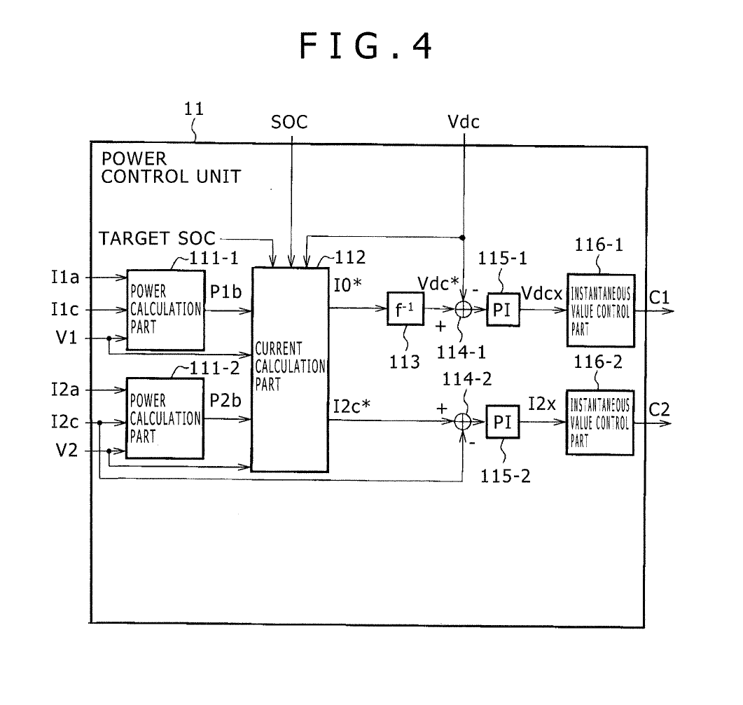

FIG. 4 is a diagram showing the logical configuration of the power control unit in the first embodiment.

The power control unit 11 is provided with power calculation parts (111-1, 111-2), a current calculation part 112, a battery characteristic calculation part 113, adders/subtractors (114-1, 114-2), proportional integration controllers (115-1, 115-2), and instantaneous value control parts (116-1, 116-2). The supply current I1a, interchange current I1c and voltage V1 related to the feeder 2-1, the supply current I2a, interchange current I2c and voltage V2 related to the feeder 2-2, the SOC of the secondary battery 16, and the DC-portion voltage Vdc applied to the DC energy interchange unit 17 are input to the power control unit 11. Control signals C1 and C2 are output from the power control unit 111, based on the input information. The power calculation parts 111-1, 111-2, . . . will hereinafter be described simply as power calculation parts 111 when not distinguished from each other in particular. The instantaneous value control parts (116-1, 116-2) will hereinafter be described simply as instantaneous value control parts 116 when not distinguished from each other in particular.

The consumed/regenerative power P1b of the railway vehicle 6-1 corresponds to the difference between the supply power P1a and the interchange power P1c to the feeder 2-1. The power calculation part 111-1 calculates the consumed/regenerative power P1b of the railway vehicle 6-1 based on the supply current I1a, the interchange current I1c and the voltage V1 related to the feeder 2-1, and the following equation (1):

P1b=P1a−P1c=(I1a−I1c)×V1 (1)

Likewise, the consumed/regenerative power P2b of the railway vehicle 6-2 corresponds to the difference between the supply power P2a and the interchange power P2c to the feeder 2-2. The power calculation part 111-2 calculates the consumed/regenerative power P2b of the railway vehicle 6-2, based on the supply current I2a, the interchange current I2c and the voltage V2 related to the feeder 2-2, and the following equation (2):

P2b=P2a−P2c=(I2a−I2c)×V2 (2)

The current calculation part 112 determines based on the sum of the consumed/regenerative power (P1b, P2b) and the present SOC whether to perform a charge to the secondary battery 16 or to perform a discharge therefrom, or whether not to perform either the charge or discharge of the secondary battery 16.

For simplification in the following, it is assumed the amount of the secondary battery 16 is infinite and no restriction is imposed on charged/discharged power P0. When the supply power (P1a, P2a) are calculated to be minimized at this time, a charge/discharge power command value P0* is as represented in the following equation (3).

Since the charged/discharged power P0 of the secondary battery 16 is actually restricted by the amount of the secondary battery 16, it is necessary to incorporate any constraint conditions into the equation (3).

P0*=−(P1b+P2b) (3)

If the sum of the consumed/regenerative power (P1b, P2b) is positive (power consumption is dominant), and the current SOC is higher than the target SOC, the current calculation part 112 discharges energy corresponding to the absolute value of the sum of the consumed/regenerative power (P1b, P2b) from the secondary battery 16. This is to effectively utilize the energy stored in the secondary battery 16.

If the sum of the consumed/regenerative power (P1b, P2b) is positive (power consumption is dominant), and the current SOC is less than or equal to the target SOC, the current calculation part 112 does not perform either charge or discharge on the secondary battery 16. This is to prevent the secondary battery 16 from being an overcharged state.

If the sum of the consumed/regenerative power (P1b, P2b) is negative (regenerative power is dominant) or 0, and the current SOC is lower than the maximum SOC, the current calculation part 112 charges the energy corresponding to the absolute value of the sum of the consumed/regenerative power (P1b, P2b) to the secondary battery 16. This is to avoid the waste of regenerative power.

If the sum of the consumed/regenerative power (P1b, P2b) is negative (regenerative power is dominant) or 0, and the current SOC is greater than or equal to the maximum SOC, the current calculation part 112 does not perform either charge or discharge on the secondary battery 16. This is to prevent the secondary battery 16 from being an overcharged state.

When the energy is charged to or discharged from the secondary battery 16, the current calculation part 112 calculates a charging current command value I0* based on the following equation (4). When either charge or discharge are not performed on the secondary battery 16, the current calculation part 112 brings the charging current command value I0* to 0.

$$I 0 *= \frac{P 0 *}{Vdc} = - ( \frac{P 1 b + P 2 b}{Vdc} ) \qquad ( 4 )$$

The battery characteristic calculation part 113 calculates a DC-portion voltage command value Vdc* at the time that current corresponding to the charging current command value I0* flows in the secondary battery 16.

The adder/subtractor 114-1 subtracts the current DC-portion voltage Vdc from the DC-portion voltage command value Vdc*. The proportional integration controller 115-1 performs proportional integration control on the result of output from the adder/subtractor 114-1. Thus, the adder/subtractor 114-1 and the proportional integration controller 115-1 allow the DC-portion voltage Vdc to converge on the DC-portion voltage command value Vdc*.

The adder/subtractor 114-1 and the proportional integration controller 115-1 calculate a DC-portion voltage command Vdcx based on the following equation (5). In the equation (5), a proportional integration control function is represented as a function PI (Proportional Integral).

$$\begin{matrix}Vdcx = P I ( Vdc * - Vdc ) \\ = P I ( {f}^{- 1} ( I 0 *) - Vdc ) \\ = P I ( {f}^{- 1} ( - ( \frac{P 1 b + P 2 b}{Vdc} ) ) - Vdc )\end{matrix} \qquad ( 5 )$$

The instantaneous value control part 116-1 generates a control signal C1 for the power conversion unit 14-1 based on the DC-portion voltage command value Vdcx. The power conversion unit 14-1 performs a power conversion according to the control signal C1.

The current calculation part 112 determines an interchange power P1c interchanged from the feeder 2-1 to the DC energy interchange unit 17 and an interchange power P2c interchanged from the feeder 2-2 to the DC energy interchange unit 17 based on the consumed/regenerative power (P1b, P2b).

When the consumed/regenerative power P1b is positive and the consumed/regenerative power P2b is negative, or when the consumed/regenerative power P1b is negative and the consumed/regenerative power P2b is positive, the power of the smaller one of the absolute value of the consumed/regenerative power P1b and the absolute value of the consumed/regenerative power P2b is interchanged from the feeder 2 having regenerative power to the feeder 2 consuming power.

If the charged/discharged power P0 of the secondary battery 16 is not 0, the current calculation part 112 further determines the feeder 2 related to the larger one of the absolute value of the consumed/regenerative power P1b and the absolute value of the consumed/regenerative power P2b, and then adds the charged/discharged power P0 to interchange power from this feeder 2. Thus, the current calculation part 112 determines interchange current command values (P1c*, P2c*).

The current calculation part 112 determines an interchange current command value I2c* based on the determined interchange power command value P2c*, the voltage V2, and the following equation (6):

$$I 2 c *= \frac{P 2 c *}{V 2} \qquad ( 6 )$$

The adder/subtractor 114-2 subtracts the current interchange current I2c from the interchange current command value I2c*. The proportional integration controller 115-2 performs a proportional integration control on the result of output from the adder/subtractor 114-2. Thus, the adder/subtractor 114-2 and the proportional integration controller 115-2 allow the interchange current I2c to converge on the interchange current command value I2c*.

The adder/subtractor 114-2 and the proportional integration controller 115-2 calculate an interchange current command value I2x based on the following equation (7). In the equation (7), a proportional integration control function is represented as a function PI.

$$\begin{matrix}I 2 x = P I ( I 2 c * - I 2 c ) \\ = P I ( \frac{P 2 c *}{V 2} - I 2 c )\end{matrix} \qquad ( 7 )$$

The instantaneous value control part 116-2 generates a control signal C2 for the power conversion unit 14-2 based on the interchange current command value I2x. The power conversion unit 14-2 performs a power conversion according to the control signal C2.

In the way described above, the power control unit 11 generates the control signals (C1, C2) and interchanges power between the feeders (2-1, 2-2).

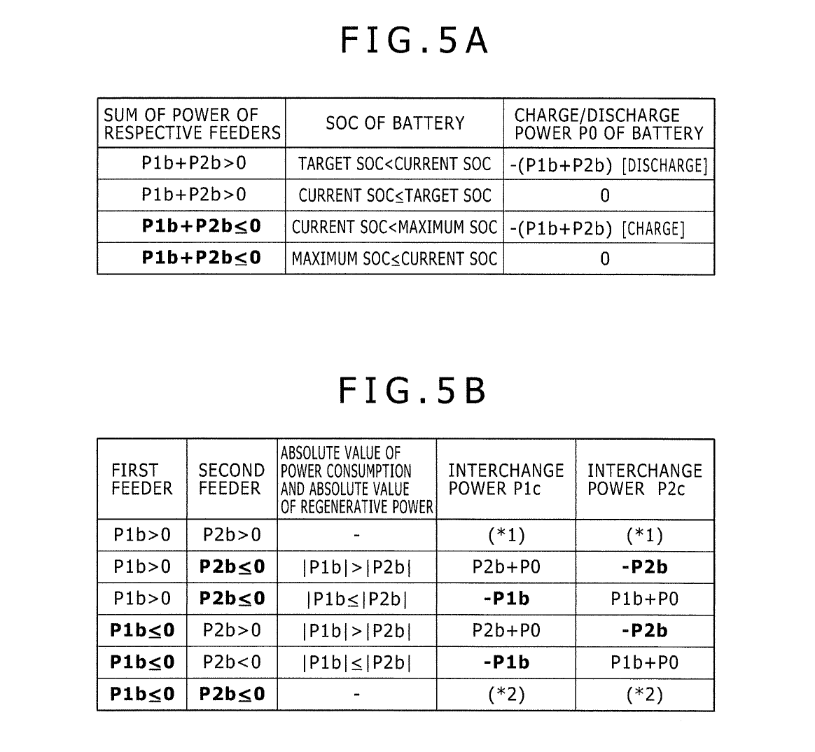

FIGS. 5A, 5B are diagrams showing the calculation of charge and discharge amount and the calculation of interchange amount in the first embodiment.

FIG. 5A is a diagram showing a method of calculating the charge and discharge amount.

If the sum of the consumed/regenerative power (P1b, P2b) is positive (power consumption is dominant) and the current SOC is higher than the target SOC, the power converter 1 serves to discharge energy corresponding to the sum of the consumed/regenerative power (P1b, P2b) from the secondary battery 16. When the energy is discharged from the secondary battery 16, the charged/discharged power P0 becomes negative. That is, the charged/discharged power P0 is represented by the above equation (3).

If the sum of the consumed/regenerative power (P1b, P2b) is positive (power consumption is dominant), and the current SOC is less than or equal to the target SOC, the power converter 1 does not perform either charge or discharge on the secondary battery 16. That is, the charged/discharged power P0 becomes 0.

If the sum of the consumed/regenerative power (P1b, P2b) is negative (regenerative power is dominant) or 0, and the current SOC is lower than the maximum SOC, the power converter 1 serves to charge energy corresponding to a value obtained by multiplying the sum of the consumed/regenerative power (P1b, P2b) by (−1) to the secondary battery 16. That is, the charged/discharged power P0 is expressed by the above equation (3).

If the sum of the consumed/regenerative power P1b and P2b is negative (regenerative power is dominant) or 0, and the current SOC is greater than or equal to the maximum SOC, the power converter 1 does not perform either charge or discharge on the secondary battery 16. That is, the charged/discharged power P0 becomes 0.

FIG. 5B is a diagram showing a method of calculating the interchange amount.

If the consumed/regenerative power P1b is positive (power is consumed), and the consumed/regenerative power P2b is positive (power is consumed), no power is interchanged between the feeders 2. The power converter 1 determines the interchanged power (P1c, P2c), based on the charged/discharged power P0. In the drawing, this case is denoted by (*1).

If the consumed/regenerative power P1b is positive (power is consumed), the consumed/regenerative power P2b is negative (power is regenerated) or 0, and the absolute value of P2b is smaller than the absolute value of P1b, the power converter 1 takes the interchange power P2c from the feeder 2-2 as (−P2b) and takes the interchange power P1c from the feeder 2-1 as (P2b+P0).

If the consumed/regenerative power P1b is positive (power is consumed), the consumed/regenerative power P2b is negative (power is regenerated) or 0, and the absolute value of P1b is smaller than or equal to the absolute value of P2b, the power converter 1 takes the interchange power P1c from the feeder 2-1 as (−P1b) and takes the interchange power P1c from the feeder 2-1 as (P1b+P0).

If the consumed/regenerative power P1b is negative (power is regenerated) or 0, the consumed/regenerative power P2b is positive (power is consumed), and the absolute value of P2b is smaller than the absolute value of P1b, the power converter 1 takes the interchange power P2c from the feeder 2-2 as (−P2b) and takes the interchange power P1c from the feeder 2-1 as (P2b+P0).

If the consumed/regenerative power P1b is negative (power is regenerated) or 0, the consumed/regenerative power P2b is positive (power is consumed), and the absolute value of P1b is smaller than or equal to the absolute value of P2b, the power converter 1 takes the interchange power P1c from the feeder 2-1 as (−P1b) and takes the interchange power P1c from the feeder 2-1 as (P1b+P0).

If the consumed/regenerative power P1b is negative (power is regenerated) or 0, and the consumed/regenerative power P2b is negative (power is regenerated) or 0, no power is interchanged between the feeders 2. The power converter 1 determines the interchanged power (P1c, P2c) based on the charged/discharged power P0. In the drawing, this case is denoted by (*2).

### Advantages of First Embodiment

In the first embodiment described above, the following advantages (A) through (E) are brought about.

(A) Between the two feeders 2, the regenerative power is interchanged and utilized from the feeder 2 through which the railway vehicle 6 is regenerating the power, to the feeder 2 on the consumption side, and the power that was not able to be interchanged is stored in the secondary battery 16. Thus, when each of the feeders 2 starts consuming or using up power again the power stored in the secondary battery 16 can be effectively utilized.

(B) If the SOC of the secondary battery 16 does not satisfy the predetermined condition, the DC-portion voltage Vdc of the DC energy interchange unit 17 is determined in such a manner that the charge/discharge to/from the secondary battery 16 is not performed. Thus, the secondary battery 16 can be controlled to be a predetermined charge amount without providing the switches or the like between the secondary battery 16 and the DC energy interchange unit 17.

(C) The power control unit 11 determines the DC-portion voltage Vdc of the DC energy interchange unit 17 in such a manner that the energy corresponding to the sum of the consumed/regenerative power of the two feeders (2-1, 2-2) is input and output to and from the secondary battery 16. Thus, the power that cannot be interchanged between the feeders (2-1, 2-2) can be stored in the secondary battery 16 without providing a voltage conversion circuit or the like between the secondary battery 16 and the DC energy interchange unit 17, and the stored power can be utilized.

(D) The battery units (161-1 to 161-3) are connected between the central point 17C and the positive point 17P. The battery units (161-4 to 161-6) are connected between the central point 17C and the negative point 17N. The voltage equal to half of the DC-portion voltage Vdc is applied to each of the battery units 161. Thus, one having a breakdown voltage equal to half of the DC-portion voltage Vdc can be used as each battery unit 161.

(E) Each of the battery units 161 is configured so as to be separated from the DC energy interchange unit 17 by the switch circuit 163. Thus, the battery unit 161 can easily be exchanged upon the occurrence of a fault in each battery unit 161, thereby making it possible to improve maintainability of the power converter 1.

### Second Embodiment

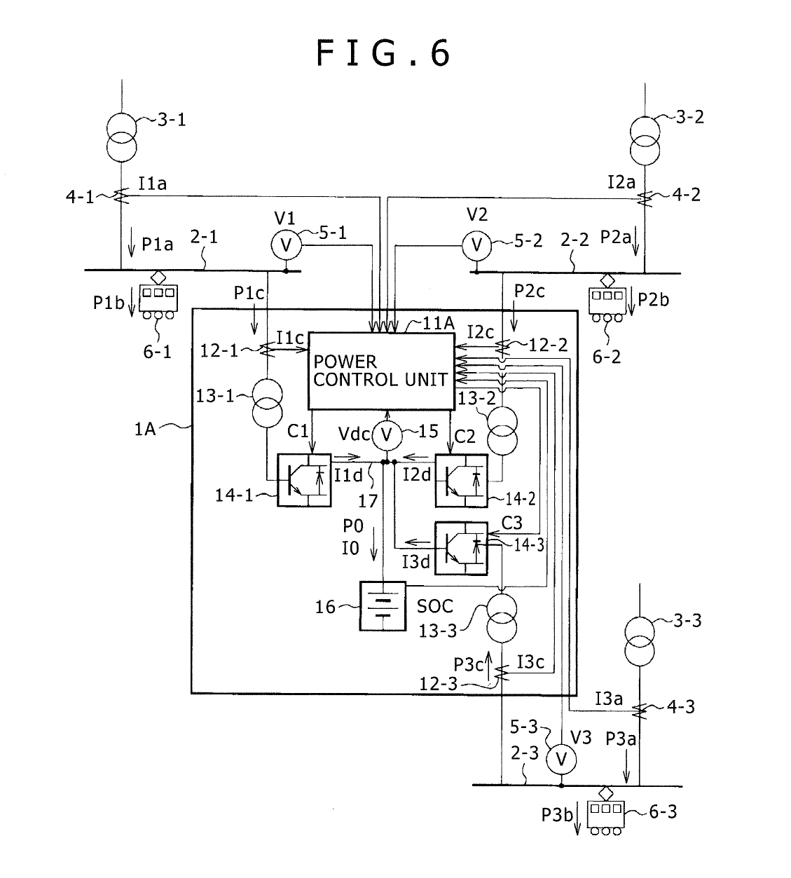

FIG. 6 is a schematic configuration diagram showing a power converter 1A according to a second embodiment. The same components as those in the power converter 1 of the first embodiment shown in FIG. 1 are identified by like reference numerals.

The power converter 1A according to the second embodiment is connected to feeders (2-1, 2-2) in a manner similar to the power converter 1 according to the first embodiment and further connected to a feeder 2-3 (third feeder), and serves to mutually exchange and share power among these feeders (2-1 to 2-3).

The feeder 2-1 is different from the feeder 2-1 (refer to FIG. 1) of the first embodiment and supplied with a single-phase AC by a transformer 3-1. The transformer 3-1 has one end connected to an unillustrated three-phase AC system and the other end connected to the feeder 2-1 via an ammeter 4-1. The configurations other than those are similar to the feeder 2-1 (refer to FIG. 1) of the first embodiment.

The feeders (2-2, 2-3) are similar to the feeder 2-1.

In addition to the power converter 1 (refer to FIG. 1) according to the first embodiment, the power converter 1A is further equipped with an ammeter 12-3 that measures an interchange current 13c, a transformer 13-3, and a power conversion unit 14-3 that mutually converts power. Furthermore, the power converter 1A is equipped with a power control unit 11A different from the power control unit 11 (refer to FIG. 1) of the first embodiment.

The ammeter 12-3 is similar to the ammeters (12-1, 12-2) (refer to FIG. 1).

The transformer 13-3 is similar to the transformers (13-1, 13-2) (refer to FIG. 1).

The power conversion unit 14-3 is similar to the power conversion units (14-1, 14-2) (refer to FIG. 1). The power conversion unit 14-3 is controlled by a control signal C3 to allow a current I3d to flow through a DC energy interchange unit 17.

Not limited to the above, feeders 2 of four systems or more may be connected to the power converter 1A. Further, a secondary battery 16 may not be connected thereto.

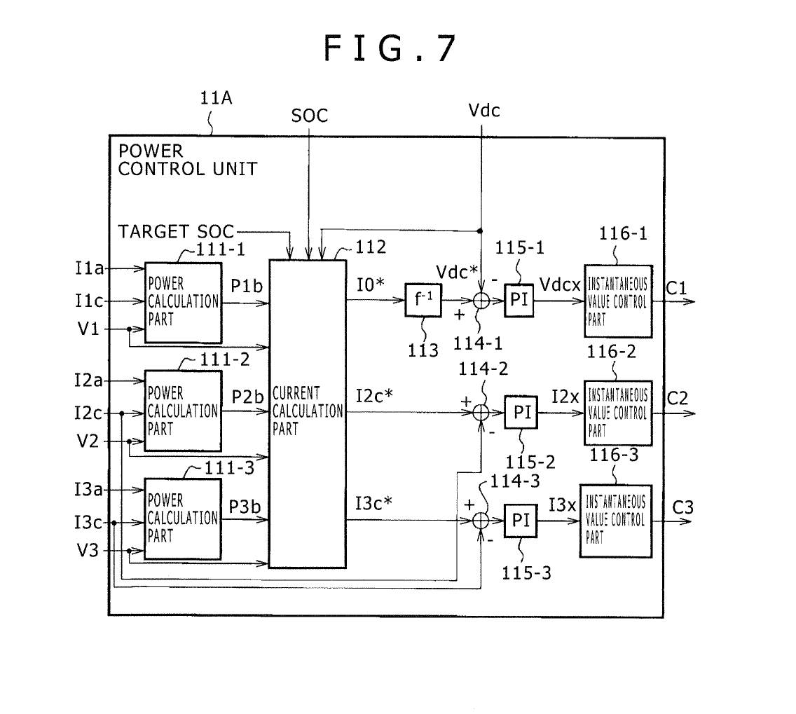

FIG. 7 is a diagram showing a logical configuration of the power control unit 11A in the second embodiment. The same components as those in the power control unit 11 of the first embodiment shown in FIG. 4 are identified by like reference numerals.

The power control unit 11A is further provided with a power calculation part 111-3, an adder/subtractor 114-3, a proportional integration controller 115-3, and an instantaneous value control part 116-3 in addition to the power control unit 11 of the first embodiment.

The power control unit 11A is input with a supply current I1a, an interchange current I1c and a voltage V1 related to the feeder 2-1, a supply current I2a, an interchange current I2c and a voltage V2 related to the feeder 2-2, a supply current I3a, an interchange current I3c and a voltage V3 related to the feeder 2-3, an SOC of the secondary battery 16, and a DC-portion voltage Vdc applied to the DC energy interchange unit 17. The power control unit 11A outputs control signals (C1, C2, C3) based on what is input thereto.

A method of calculating the control signal C3 is similar to the method of calculating the control signal C2 in the first embodiment (refer to FIG. 4).

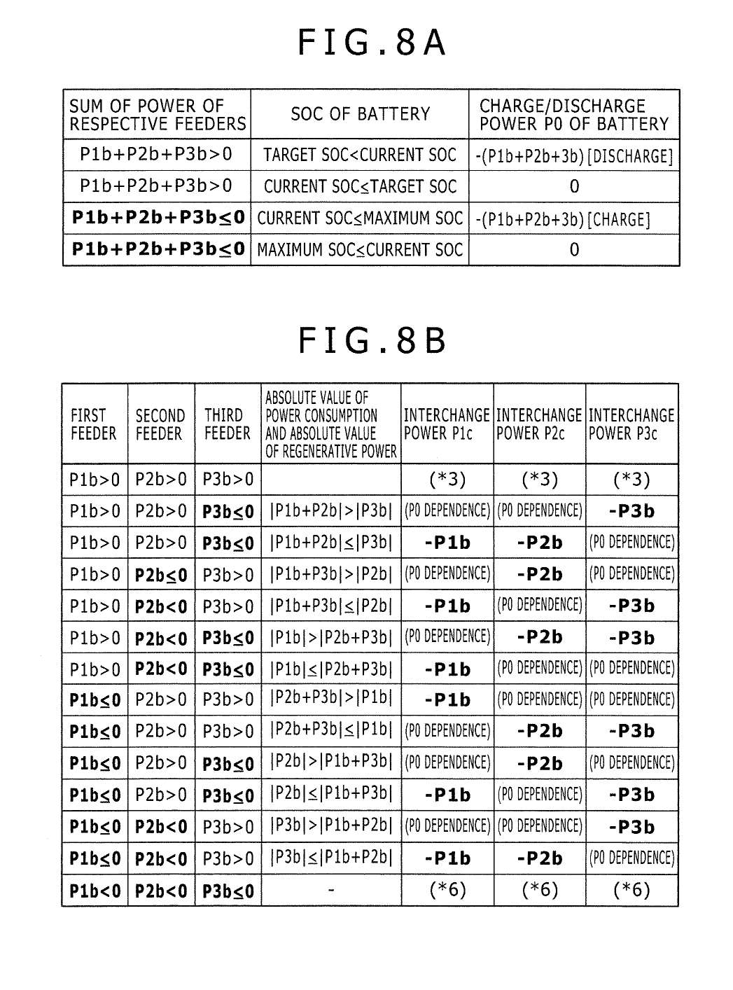

FIGS. 8A, 8B are diagrams showing the calculation of charge and discharge amount and the calculation of interchanged amount in the second embodiment.

FIG. 8A is a diagram showing a method of calculating the charge and discharge amount.

If the sum of consumed/regenerative power (P1b to P3b) is positive (power consumption is dominant) and the current SOC is higher than a target SOC, the power converter 1A serves to discharge energy corresponding to the sum of the consumed/regenerative power (P1b to Pb3) from the secondary battery 16.

If the sum of the consumed/regenerative power (P1b to P3b) is positive (power consumption is dominant) and the current SOC is less than or equal to the target SOC, the power converter 1A does not perform either charge or discharge of the secondary battery 16. That is, a charged/discharged power P0 becomes 0.

If the sum of the consumed/regenerative power (P1b to P3b) is negative (regenerative power is dominant) or 0, and the current SOC is lower than the maximum SOC, the power converter 1A serves to charge energy corresponding to a value obtained by multiplying the sum of the consumed/regenerative power (P1b to P3b) by (−1) to the secondary battery 16.

If the sum of the consumed/regenerative power (P1b to P3b) is negative (regenerative power is dominant) or 0, and the current SOC is greater than or equal to the maximum SOC, the power converter 1A does not perform either charge or discharge of the secondary battery 16. That is, the charged/discharged power P0 becomes 0.

FIG. 8B is a diagram showing a method of calculating the interchanged amount.

If the consumed/regenerative power (P1b to P3b) is all positive (power consumption), no power is interchanged between the feeders 2. The power converter 1A determines the interchanged power (P1c to P3c) based on the charged/discharged power P0. In the drawing, this case is denoted by (*3).

If any of the consumed/regenerative power (P1b to P3b) is positive (power consumption) and others thereof are negative (power regeneration) or 0, and the absolute of the sum of regenerative power is larger than or equal to the absolute value of the sum of consumed power, the power converter 1A interchanges consumed power from the respective feeder 2 each related to the regenerative power to all feeders 2 each related to the consumed power. The power converter 1A further interchanges power from each feeder 2 related to the regenerative power according to the charged/discharged power P0 and thereby charges the secondary battery 16. In the drawing, this case is described as (P0 dependence).

If any of the consumed/regenerative power (P1b to P3b) is positive (power consumption) and the others thereof are negative (power regeneration) or 0, and the absolute of the sum of the regenerative power is smaller than the absolute value of the sum of the consumed power, the power converter 1A interchanges regenerative power from all feeder 2 through which the regenerative power is being generated, to the respective feeders 2 each related to the consumed power. The power converter 1A further interchanges power from the secondary battery 16 to each feeder 2 related to the consumed power according to the charged/discharged power P0. In the drawing, this case is described as (P0 dependence).

If all the consumed/regenerative power (P1b to P3b) is negative (power regeneration) or 0, no power is interchanged between the feeders 2. The power converter 1A determines the interchanged power (P1c to P3c) based on the charged/discharged power P0. In the drawing, this case is denoted by (*6).

### Advantages of Second Embodiment

In the second embodiment described above, the following advantages of (F) through (H) are brought about.

(F) The power converter 1A mutually interchanges the regenerative power among at least three systems: feeders (2-1 to 2-3), which reduces a case where the secondary battery needs to be charged due to the simultaneous occurrence of regenerative power in plural feeders. The regenerative power generated in the feeders 2, therefore, can be effectively utilized either when the secondary battery is small in amount or when no secondary battery is provided.

(G) The power control unit 11A compares the absolute value of the sum of power of the feeders 2 in which consumed power is being generated and the absolute value of the sum of power of the feeders 2 in which regenerative power is being generated, and then takes the smaller one of the absolute values as a power interchange amount. Thus, even when the feeders 2 of the three systems or more are connected, it is possible to easily calculate a power interchange amount.

(H) One of the power conversion units 14 determines the DC-portion voltage Vdc of the DC energy interchange unit 17 and the others determine a current interchanged between the respective feeders 2. Thus, even when the feeders 2 of the three systems or more are connected, the DC-portion voltage Vdc can be determined in such a manner that desired charge/discharge power can be input and output to and from the secondary battery 16, and the desired power can be interchanged between the respective feeders 2.

### Third Embodiment

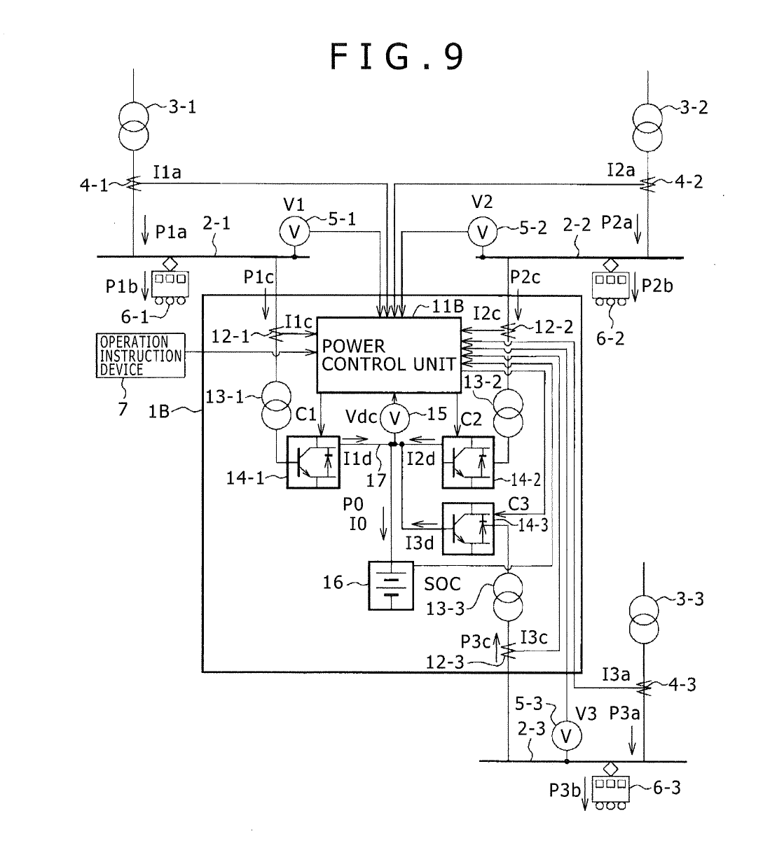

FIG. 9 is a schematic configuration diagram showing a power converter 1B according to a third embodiment. The same components as those in the power converter 1A of the second embodiment shown in FIG. 6 are identified by like reference numerals.

The power converter 1B according to the third embodiment is connected with an operation instruction device 7 in addition to the power converter 1A (refer to FIG. 6) of the second embodiment and provided with a power control unit 11B different from the power control unit 11A (refer to FIGS. 6 and 7) of the second embodiment.

The operation instruction device 7 is connected to railway vehicles (6-1 to 6-3) so as to be able to communicate therewith through cables (not shown) or the like. The operation instruction device 7 instructs the respective railway vehicles (6-1 to 6-3) to run, and at the same time, obtains and manages operation information on the railway vehicles. The operation instruction device 7 outputs the operation information of the respective railway vehicles (6-1 to 6-3) to the power control unit 11B of the power converter 1B. The operation information includes an operation diagram, the present speed of the railway vehicles (6-1 to 6-3), and information on their operations (during instruction of their acceleration or deceleration).

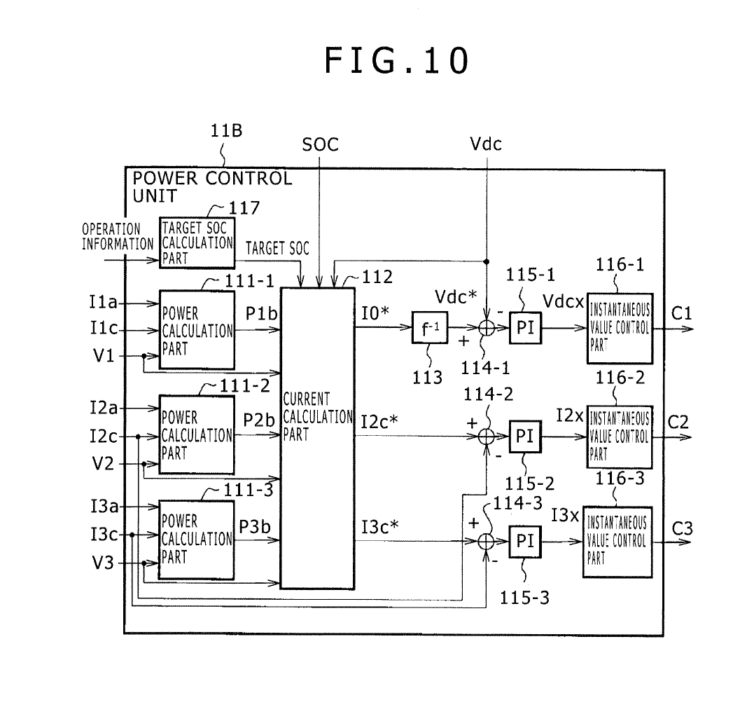

FIG. 10 is a diagram showing a logical configuration of the power control unit 11B in the third embodiment. The same components as those in the power control unit 11A of the second embodiment shown in FIG. 7 are identified by like reference numerals.

The power control unit 11B of the third embodiment is further equipped with a target SOC calculation part 117 in addition to the power control unit 11A (refer to FIG. 7) of the second embodiment.

The target SOC calculation part 117 calculates a target SOC based on the operation information. When, for example, the present speed of the respective railway vehicles (6-1 to 6-3) exceed a prescribed value, and a probability of regenerative power generated due to the deceleration is high, the target SOC calculation part 117 decreases the target SOC to make it easy to charge the regenerative power to the secondary battery 16. When the railway vehicles (6-1 to 6-3) are at a stop, and a probability of consumed power generated due to the acceleration is high, the target SOC calculation part 117 further increases the target SOC to make it easy to accommodate (discharge) the consumed power from the secondary battery 16.

Not limited to the examples above, the target SOC calculation part 117 may determine that a probability of the regenerative power canceled by the consumed power will be low, and may increase the target SOC when the target SOC calculation part 117 detects from the operation diagram that the number of the railway vehicles 6 running on the feeders 2 is low.

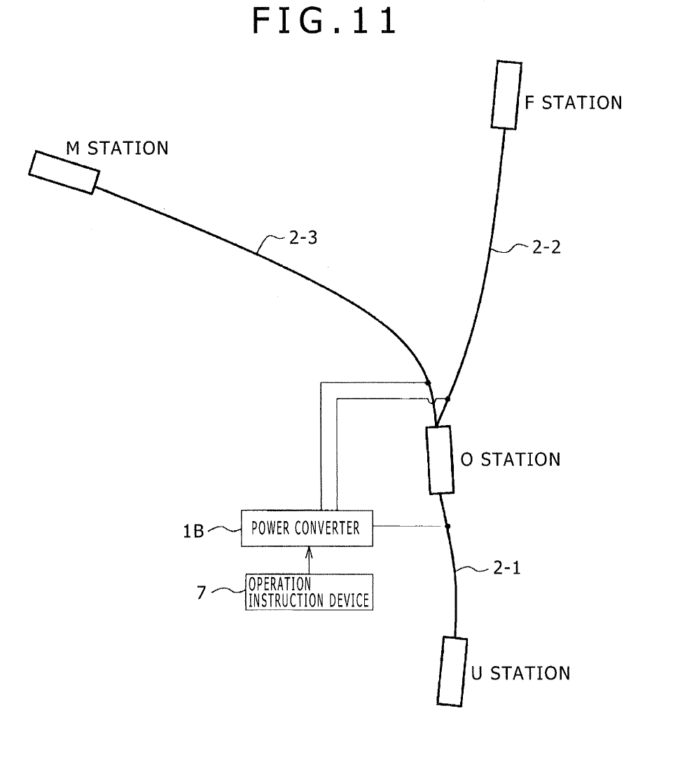

FIG. 11 is a diagram showing a relationship between railway lines and feeders 2 in the third embodiment.

The power converter 1B is connected to a feeder 2-1 related to a railway line from U and O stations, a feeder 2-2 related to a railway line from the O station to an F station, and a feeder 2-3 related to a railway line from the O station to an M station and mutually interchanges regenerative power among these three-system feeders (2-1 to 2-3). The operation instruction device 7 is connected to the power converter 1B, and the target SOC is adjusted to be the most appropriate target SOC by the operation instruction device 7.

### Advantages of Third Embodiment

In the third embodiment described above, the following advantages of (I) is brought about.

(I) The target SOC calculation part 117 predicts a probability of occurrence of the regenerative power based on the operation instruction information and then increases or decreases the target SOC. It is thus possible to further charge the regenerative power to the secondary battery 16.

### Modifications

The present invention is not limited to the above embodiments and includes various modifications. For example, the above embodiments are described in detail to explain the present invention in an easy way to understand, but is not necessarily limited to one equipped with all constituents described. Some of constituents of one embodiment can be replaced with constituents of another embodiment. The constituents of another embodiment can also be added to the constituents of the one embodiment. The addition, deletion, and replacement of other constituents can also be performed on some of the constituents of each embodiment.

In the respective constitutions, functions, processing parts, processing means and the like described above, some or all thereof may be implemented by hardware such as an integrated circuit or the like. The above respective constitutions, functions and the like may be implemented using software by causing a processor to interpret and execute a program for executing the respective functions. Information about the program, tables, files and the like that execute the respective functions can be kept in a recording device such as a memory, hard disk, SSD (Solid State Drive) or the like, or a recording medium such as an IC card, an SD card, a DVD (Digital Versatile Disk) or the like.

In the respective embodiments, there are shown as control lines and information lines, those considered to be necessary for convenience of explanation. All the control lines and information lines are not necessarily shown in terms of products. Actually, almost all constituents may be considered to have been mutually connected to each other.

As the modifications of the present invention, the following (a) through (c) are illustrated by way of example.

(a) The single-phase AC of the BT feeding system flows through the feeders 2 employed in the first through third embodiments. However, not only this, but the current of a DC feeding system, an AT (Auto Transformer) feeding system or the like may flow through the feeders 2. The feeders 2 may also supply power with a coaxial cable feeding basis.

(b) The power converter 1 according to the first embodiment may interchange power so as to suppress power imbalance between the feeders (2-1, 2-2).

(c) The feeders 2 employed in the first through third embodiments supply power to each railway vehicle 6. However, not only this, but the feeders 2 may supply power to vehicles including a trolley bus, an electric vehicle, a monorail, a cable car, and a ropeway.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A power converter comprising:
a plurality of power conversion units each connected to a different feeder;
a DC energy interchange unit connected to the power conversion units and secondary battery; and
a power control unit, wherein the power control unit instructs a regeneration-side power conversion unit connected to a regeneration-side feeder of the feeders, through which a regenerative current flows, and a consumption-side power conversion unit connected to the consumption-side feeder through which a current consumption flows, to output power from the regeneration-side feeder to the consumption-side feeder through the DC energy interchange unit, and wherein
the power control unit also determines a voltage of the DC energy interchange unit in such a manner as to input/output energy corresponding to the sum of regenerative power of the regeneration-side feeder and consumed power of the consumption-side feeder to and from the secondary battery.

2. The power converter according to claim 1, wherein
the DC energy interchange unit includes means for measuring the voltage and is connected with a communication line which transmits the measured value of voltage to the power control unit.

3. The power converter according to claim 1, wherein
the power conversion units each include an instrument for measuring a current flowing from the feeders to which the power conversion units are connected, and wherein
the power conversion units are connected with a communication line transmitting the measured value of a current to the power control unit and with the communication line which receives a control value instructed from the power control unit.

4. The power converter according to claim 1, wherein
if a charge amount of the secondary battery does not satisfy a predetermined condition, the power control unit determines the voltage of the DC energy interchange unit in such a manner as not to input/output the energy corresponding to the sum of the regenerative power and the consumed power to and from the secondary battery.

5. The power converter according to claim 1, wherein
if the sum of the absolute value of the regenerative power of the feeders on the regeneration side is larger than the sum of the absolute value of the consumed power of the feeders on the consumption side, and the charge amount of the secondary battery is less than a maximum charge amount, the power control unit determines the voltage of the DC energy interchange unit so as to input energy to the secondary battery, and wherein
if the sum of the absolute value of the regenerative power is smaller than the sum of the absolute value of the consumed power, and the charge amount of the secondary battery is greater than or equal to a target charge amount, the power control unit determines the voltage of the DC energy interchange unit so as to output energy from the secondary battery.

6. The power converter according to claim 1, further including a secondary battery control unit which detects the charge amount of the secondary battery.

7. The power converter according to claim 6, wherein
if the charge amount detected by the secondary battery control unit satisfies a predetermined condition, the power control unit further controls each of the power conversion units so as to input/output energy corresponding to the sum of the regenerative power and the consumed power of the feeders to and from the secondary battery.

8. The power converter according to claim 6, wherein
the secondary battery has a plurality of battery units connected in parallel, the battery units each including battery modules connected in series.

9. The power converter according to claim 8, wherein
the DC energy interchange unit includes a grounded central point, a positive point to which a positive DC voltage is applied, and a negative point to which a negative DC voltage is applied, and wherein
the battery units are each connected between the central point and the positive point and between the negative point and the central point.

10. The power converter according to claim 8, wherein
the secondary battery is provided with a switch circuit controlled by the secondary battery control unit, and wherein
the secondary battery is capable of being separated from the DC energy interchange unit for every battery unit.

11. The power converter according to claim 8, wherein
the power control unit further obtains operation information of a vehicle driven by the power of the feeders and adjusts a target charge amount of the secondary battery.

12. A power converter comprising:
a plurality of power conversion units each connected to a different feeder;
a DC energy interchange unit connected to the power conversion units; and
a power control unit which instructs the regeneration-side power conversion unit connected to the regeneration-side feeder of the feeders, through which a regenerative current flows, and the consumption-side power conversion unit connected to the consumption-side feeder through which a current consumption flows, to output power from the regeneration-side feeder to the consumption-side feeder through the DC energy interchange unit.

13. A power converting method for a power converter, the power converter comprising a plurality of power conversion units each connected to a different feeder, a DC energy interchange unit connected to the power conversion units and connected to a secondary battery, and a power control unit, the power control unit performing the steps of:
instructing the regeneration-side power conversion unit connected to the regeneration-side feeder of the feeders, through which a regenerative current flows, and the consumption-side power conversion unit connected to the consumption-side feeder through which a current consumption flows, to output power from the regeneration-side feeder to the consumption-side feeder through the DC energy interchange unit; and
determining the voltage of the DC energy interchange unit in such a manner as to input/output energy corresponding to the sum of regenerative power of the regeneration-side feeder and consumed power of the consumption-side feeder to and from the secondary battery.
